(19) United States
(12) Patent Application Publication
(10) Pub. No.: US 2025/0308291 A1
(43) Pub. Date: Oct. 2, 2025

(54) METHOD FOR PROVIDING EXHIBITION INFORMATION

(71) Applicant: INVENTIS CO., LTD., Seoul (KR)

(72) Inventor: Hoontack OH, Seongnam-si (KR)

(73) Assignee: INVENTIS CO., LTD., Seoul (KR)

(21) Appl. No.: 18/619,577

(22) Filed: Mar. 28, 2024

(51) Int. Cl. G07B 11/00; G07C 9/25

(52) U.S. Cl. CPC G07B 11/00; G07C 9/257

(57) ABSTRACT

A method for providing exhibit information is disclosed. The method according to one example of the present disclosure includes obtaining visit information of a first user terminal for a plurality of spots existing in an exhibition hall, and transmitting information about a first type of a second spot existing in the exhibition hall to the first user terminal based on a determination that a time for which the first user terminal has stayed at a first type of a first spot is equal to or more than a reference value. In addition, the visit information of the first user terminal may be obtained as a result of tracking a location of the first user terminal within the exhibition hall, and the visit information of the first user terminal may include a time for which the first user terminal has stayed at each of a plurality of spots.

### TECHNICAL FIELD

The present disclosure is related to a method for providing exhibition information and a computing system to which the method is applied. More specifically, the present disclosure relates to a method for automatically identifying unauthorized visitors to an exhibition hall and a system in which the method is applied.

### BACKGROUND

Conventionally, in order to verify the validity of visitors' admission tickets when the visitors enter an exhibition hall, the staff at the exhibition hall manually checks the mobile or physical admission tickets. In addition to causing unnecessary wastage of human resources, the above-mentioned conventional method also suffered from the problem that the staff misunderstood the information on the ticket, allowing unauthorized visitors to enter the exhibition hall.

In addition, even if the staff is informed that an unauthorized visitor has entered, it is difficult to locate the unauthorized visitor due to the crowds in the exhibition hall.

On the other hand, at exhibitions such as job fairs, where it is inevitable to provide visitor information in order to provide services to visitors to the booths operated in the exhibition hall, visitor information may be provided to a booth operator orally or by handwritten notes. In the above case, it was difficult to serve more visitors at the booth due to the time it takes to provide information to visitors.

In an exhibition hall, booths of different categories are generally operated simultaneously, and conventionally, information about booths corresponding to the preferences of each visitor is provided through an application that can be executed on a user terminal of a visitor associated with the exhibition hall. However, the problem with the above method is that it is difficult to accurately predict the preferences of each visitor, and as a result, the application only provides information about booths that are far from the visitor's purpose of visiting the exhibition hall.

Furthermore, conventional indoor positioning technology methods do not accurately track the location of user devices indoors and do not provide sufficient services using the information obtained as a result of tracking the location of the user devices indoors.

In order to solve the above technical challenges, there is a need for a method for accurately predicting a visitor's preference information for each booth category, a method for automatically providing the visitor's information to the booth operator as needed, and a method for identifying whether an unauthorized visitor has entered and the current location of the unauthorized visitor in the exhibition hall, but the above methods have not been provided in the related art due to technical difficulties.

### DETAILED DESCRIPTION

### Object

The technical problem to be solved through some examples of the present disclosure is to provide a method to automatically identify unauthorized visitors who have entered an exhibition hall and have not purchased a valid admission ticket.

Another technical problem to be solved through some examples of the present disclosure is to provide a method of automatically specifying the location of unauthorized visitors within the exhibition hall.

Still another technical problem to be solved through some examples of the present disclosure is to provide a method of automatically transmitting visitor information to a spot management terminal corresponding to a specific spot within the exhibition hall.

Still another technical problem to be solved through some examples of the present disclosure is to provide a method of predicting preference information for each booth category of each visitor entering the exhibition hall.

The technical problems of the present disclosure are not limited to the technical problems described above, and other technical problems not mentioned will be clearly understood by those skilled in the art from the description below.

### Means

In order to solve the above technical problems, a method of monitoring visitors according to one example of the present disclosure includes identifying a first user terminal approaching within a predefined range of a gate, identifying whether a first admission ticket corresponding to the first user terminal is valid in response to identifying the first user terminal approaching the gate, obtaining visual feature information of a first user from a user-identified image of the first user of the first user terminal captured by an imaging device of the gate when the first admission ticket is identified as invalid, mapping identifier information of the first user terminal and the visual feature information of the first user based on the obtained visual feature information of the first user and location information of the first user terminal, and displaying an alarm on a visitor monitoring screen when the first admission ticket is identified as invalid, in which displaying the alarm on the visitor monitoring screen includes identifying the first user by using the visual feature information of the first user in an image captured by a first imaging device capable of capturing the image corresponding to a location of the first user terminal among a plurality of imaging devices in an exhibition hall, based on the location information of the first user terminal, marking the first user in the image captured by the first imaging device and displaying the image on the visitor monitoring screen, and displaying the user-identified image of the first user and the image captured by the first imaging device together on the visitor monitoring screen. In addition, the user-identified image may be captured when the first admission ticket is identified as invalid by the imaging device of the gate, and identifying whether the first admission ticket is valid may include determining whether a predefined parameter value included in the first admission ticket is within a valid range.

In order to solve the above technical problems, a method of monitoring visitors according to one example of the present disclosure includes identifying a first user terminal entering an exhibition hall, and transmitting information of a first user corresponding to the first user terminal to a spot management terminal at a first spot in response to identifying that a first condition is satisfied, when a location of the first user terminal reaches the first spot that is one of a plurality of spots existing in the exhibition hall.

In some examples, identifying the first user terminal entering the exhibition hall may includes identifying the first user terminal approaching within the predefined range of the gate, identifying whether the first admission ticket corresponding to the first user terminal is valid in response to identifying the first user terminal approaching the gate, and determining the first user terminal entering the exhibition hall when the first admission ticket is identified as valid.

In some examples, the first condition may be that the first user terminal stays in a first area or a second area of the first spot for more than a reference time.

In some examples, the first condition may be that the first spot is one of the spots predefined by the first user.

In some examples, the first condition may be that the information of the first user satisfies conditions predefined by the spot management terminal at the first spot.

In some examples, the method may include not transmitting the information of the first user to the spot management terminal at the first spot when movement of the first user terminal corresponds to a predefined gesture as a result of tracking the location of the first user terminal.

In order to solve the above technical problems, a method of monitoring visitors according to another example of the present disclosure includes obtaining visit information of a first user terminal for a plurality of spots existing in an exhibition hall, and transmitting information about a first type of a second spot existing in the exhibition hall to the first user terminal based on a determination that a time for which the first user terminal has stayed at a first type of a first spot is equal to or more than a reference value. In addition, the visit information of the first user terminal may be obtained as a result of tracking a location of the first user terminal within the exhibition hall, and the visit information of the first user terminal may include a time for which the first user terminal has stayed at each of a plurality of spots.

In some examples, obtaining the visit information of the first user terminal for the plurality of spots existing in the exhibition hall may include calculating each of a usage time and a waiting time of the first user terminal at the first spot, and applying a first weight to the usage time of the first user terminal at the first spot and applying a second weight to the waiting time at the first spot to determine a time for which the first user terminal has stayed at the first spot. Here, the usage time of the first user terminal at the first spot may be a time for which the first user terminal has stayed inside a first area inside the first spot.

In some examples, calculating the waiting time of the first user terminal at the first spot may include identifying that the first user terminal staying within a second area outside the first spot for a time equal to or more than a threshold, and determining a time for which the first user terminal has stayed in the second area of the first spot as the waiting time of the first user terminal at the first spot when it is identified that the first user terminal has reached the first area of the first spot. Here, the second area may be at least a portion of a predefined adjacent area of the first spot.

In some examples, the method may further include determining that the first user terminal has not stayed at the first spot when the first user terminal has reached the first area of the adjacent spot corresponding to the first spot.

In some examples, the method may further include transmitting information about a first type of a third spot to the first user terminal when the visit information of the first user terminal includes the visit information about the first type of the second spot more than a reference value. In addition, the first type of the third spot may be a spot that is not included in the visit information of the first user terminal.

In order to solve the above technical problems, an exhibition information provision system according to still another example of the present disclosure includes one or more processors, and a memory that stores a computer program executed by the one or more processors. In addition, the computer program may be stored on a computer-readable recording medium to execute: identifying a first user terminal approaching within a predefined range of a gate, identifying whether a first admission ticket corresponding to the first user terminal is valid in response to identifying the first user terminal approaching the gate, obtaining visual feature information of a first user from a user-identified image of the first user of the first user terminal captured by an imaging device of the gate when the first admission ticket is identified as invalid, mapping identifier information of the first user terminal and the visual feature information of the first user based on the obtained visual feature information of the first user and location information of the first user terminal, and displaying an alarm on a visitor monitoring screen when the first admission ticket is identified as invalid. Furthermore, displaying the alarm on the visitor monitoring screen may include: identifying the first user by using the visual feature information of the first user in an image captured by a first imaging device capable of capturing the image corresponding to a location of the first user terminal among a plurality of imaging devices in an exhibition hall, based on the location information of the first user terminal, marking the first user in the image captured by the first imaging device and displaying the image on the visitor monitoring screen, and displaying the user-identified image of the first user and the image captured by the first imaging device together on the visitor monitoring screen. In addition, the user-identified image may be captured when the first admission ticket is identified as invalid by the imaging device of the gate, and identifying whether the first admission ticket is valid may include determining whether a predefined parameter value included in the first admission ticket is within a valid range.

In order to solve the above technical problems, an exhibition information provision system according to still another example of the present disclosure includes one or more processors, and a memory that stores a computer program executed by the one or more processors. In addition, the computer program may be stored on a computer-readable recording medium to execute: identifying a first user terminal entering an exhibition hall, and transmitting information of a first user corresponding to the first user terminal to a spot management terminal at a first spot in response to identifying that a first condition is satisfied, after a location of the first user terminal reaches the first spot that is one of a plurality of spots existing in the exhibition hall.

In some examples, the first condition may be that the first spot is one of the spots predefined by the first user.

In some examples, the first condition may be that the information of the first user satisfies conditions predefined by the spot management terminal at the first spot.

In some examples, the computer program may be stored on a computer-readable recording medium to execute not transmitting the information of the first user to the spot management terminal at the first spot when movement of the first user terminal corresponds to a predefined gesture as a result of tracking the location of the first user terminal.

In order to solve the above technical problems, an exhibition information provision system according to still another example of the present disclosure includes one or more processors, and a memory that stores a computer program executed by the one or more processors.

In some examples, obtaining the visit information of the first user terminal for the plurality of spots existing in the exhibition hall may include calculating each of a usage time and a waiting time of the first user terminal at the first spot, and applying a first weight to the usage time of the first user terminal at the first spot and applying a second weight to the waiting time at the first spot to determine a time for which the first user terminal has stayed at the first spot. Here, the usage time of the first user terminal at the first spot may be a time for which the first user terminal has stayed inside a first area inside the first spot.

In some examples, calculating the waiting time of the first user terminal at the first spot may include identifying that the first user terminal staying within a second area outside the first spot for a time equal to or more than a threshold, and determining a time for which the first user terminal has stayed in the second area of the first spot as the waiting time of the first user terminal at the first spot when it is identified that the first user terminal has reached the first area of the first spot. Here, the second area may be at least a portion of a predefined adjacent area of the first spot.

### BRIEF DESCRIPTION OF DRAWINGS

FIG. 1 illustrates an exemplary environment in which an exhibition information provision system according to an example of the present disclosure can be applied.

FIG. 2 is a flowchart of a method for monitoring visitors according to one example of the present disclosure.

FIG. 3 is a diagram illustrating a step of determining whether an admission ticket of a user terminal is valid, which can be performed in some examples of the present disclosure.

FIG. 4 is a diagram illustrating some steps that can be performed when the admission ticket of the user terminal is identified as invalid according to some examples of the present disclosure.

FIG. 5 is a diagram illustrating some steps that can be performed when the admission ticket of the user terminal is identified as invalid according to some examples of the present disclosure.

FIG. 6 is a flowchart of a method for providing exhibition information according to another example of the present disclosure.

FIG. 7 is a diagram illustrating a step of transmitting user information to a spot management terminal at a specific spot, which can be performed in some examples of the present disclosure.

FIG. 8 is a flowchart of a method for providing exhibition information according to another example of the present disclosure.

FIG. 9 is a diagram illustrating a step of transmitting information related to an exhibition hall to the user terminal based on the coordinates where the user terminal is located, which can be performed in some examples of the present disclosure.

FIG. 10 is a flowchart for describing in detail several steps described with reference to FIG. 8.

FIG. 11 is a flowchart for describing in detail several steps described with reference to FIG. 10.

FIG. 12 is a diagram illustrating a step of calculating the usage time and waiting time of the user terminal at a specific spot, which can be performed in some examples of the present disclosure.

FIG. 13 is a diagram illustrating a step of transmitting information about a first type of a second spot existing in the exhibition hall to the user terminal, which can be performed in some examples of the present disclosure.

FIG. 14 is a hardware configuration diagram of a computing system, according to still another example of the present disclosure.

### DESCRIPTION OF EMBODIMENTS

Hereinafter, preferred examples of the present disclosure will be described in detail with reference to the accompanying drawings. The advantages and features of the present invention, and methods of achieving them will become apparent with reference to the examples described in detail with reference to the accompanying drawings. However, the technical idea of the present invention is not limited to the following examples, but may be implemented in various different forms, and the following examples are provided only to complete the technical idea of the present invention and to fully inform those skilled in the art to which the present invention pertains of the scope of the present invention, and the technical idea of the present invention is only defined by the scope of the claims.

In describing the present disclosure, when it is determined which a detailed description of a related known configuration or function may obscure the subject matter of the present disclosure, the detailed description thereof will be omitted.

Unless otherwise defined, terms (including technical and scientific terms) used in the following examples may be used in a sense commonly understood by those skilled in the art to which the present disclosure pertains, but may vary according to the intention or precedent of a technician working in an associated field, the emergence of new technology, and the like. The terms used in the present disclosure are intended to describe examples and are not intended to limit the scope of the present disclosure.

The singular expression used in the following examples comprises plural concepts, unless the context clearly specifies which it is singular. In addition, the plural expressions comprise a singular concept unless the context clearly specifies which it is plural.

In addition, the terms first, second, A, B, (a), (b), and the like used in the following examples are merely used to distinguish an element from another element, and the nature, sequence, or order of the element is not limited by the terms.

Prior to the description of various examples of the present disclosure, it is important to clarify the terminology used in the following examples.

In the following examples, a ‘spot’ may refer to a booth operating within an exhibition hall, but is not limited to any facility that provides services to visitors within the exhibition hall.

In the following examples, a ‘gate’ may refer to a device installed at the entrance of the exhibition hall to control entry and exit of visitors, but in some other examples, a ‘gate’ may refer to a specific point at the entrance of the exhibition hall through which an exhibition information provision system determines whether a visitor has entered.

Hereinafter, some examples of the present disclosure will be described with reference to drawings.

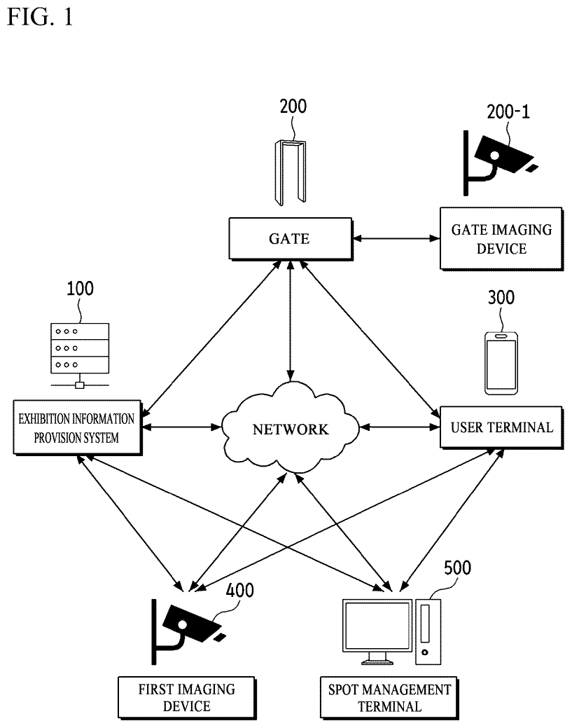

FIG. 1 illustrates an exemplary environment in which an exhibition information provision system according to an example of the present disclosure can be applied.

Each component illustrated in FIG. 1 may refer to software or hardware, such as a field programmable gate array (FPGA) or an application-specific integrated circuit (ASIC). However, the components are not limited to software or hardware, and may be configured to be in an addressable storage medium or configured to execute one or more processors. The functions provided in the components may be implemented by more subdivided components, or may be implemented as one component which performs a specific function by combining a plurality of components.

In some examples, an exhibition information provision system 100 may communicate with other components over a network. The network may be implemented as any type of wired/wireless network such as a Local Area Network (LAN), a Wide Area Network (WAN), a mobile radio communication network, and a Wireless Broadband Internet (Wibro).

A user terminal 300 and a spot management terminal 500 can be, but are not limited to, notebooks, desktops, laptops, smartphones, and tablets, and can include any type of device with computing capabilities.

In one example of the present disclosure, the exhibition information provision system 100 can identify the user terminal 300 approaching within a predefined range of a gate 200.

In some examples of the present disclosure, the exhibition information provision system 100 can identify whether the user terminal 300 has approached the gate 200 based on identifier information of the user terminal 300 transmitted by the gate 200.

In some other examples of the present disclosure, the exhibition information provision system 100 can receive a location of the user terminal 300 from the user terminal 300 and identify that the user terminal 300 has approached the gate 200 based on a determination that the location of the user terminal 300 corresponds to a location of the gate 200.

In another example of the present disclosure, the exhibition information provision system 100 can identify whether an admission ticket corresponding to the user terminal 300 is valid.

In some examples of the present disclosure, the exhibition information provision system 100 can map a first admission ticket and the user terminal 300, for example, upon receiving a purchase request for the first admission ticket of the user terminal 300.

In some other examples of the present disclosure, the exhibition information provision system 100 can identify whether the first admission ticket is valid by determining whether a predefined parameter value included in the first admission ticket is within a valid range.

For example, the above-defined parameter value may be the validity period information of the first admission ticket.

However, the validity period information of the admission ticket in the above-described example is only an example to help understand the present disclosure, and is not limited to any one predefined parameter for determining whether the admission ticket is valid.

The exhibition information provision system 100 according to another example of the present disclosure can display an alarm on a visitor monitoring screen when the admission ticket corresponding to the user terminal 300 is identified as invalid. Here, the visitor monitoring screen may be a display device included in the exhibition information provision system 100.

In some examples of the present disclosure, the exhibition information provision system 100 can obtain visual feature information of a user from the user-identified image of a user corresponding to the user terminal 300 captured by a gate imaging device 200-1 of the gate 200 when the admission ticket corresponding to the user terminal 300 is identified as invalid. Here, the visual feature information of the user may include visual features for recognizing a face of the user.

In some other examples of the present disclosure, the exhibition information provision system 100 can map and store the identifier information of the user terminal and the visual feature information of the user based on the above-obtained visual feature information of the user and the location information of the user terminal 300.

In still some other examples of the present disclosure, based on the location information of the user terminal 300, the exhibition information provision system 100 can identify a user by using visual feature information of the user in an image captured by a first imaging device 400 capable of capturing an image corresponding to the location of the user terminal 300 among a plurality of imaging devices in the exhibition hall.

In still some other examples of the present disclosure, the exhibition information provision system 100 can mark and display the user of the user terminal 300 corresponding to an invalid admission ticket in the image captured by the first imaging device 400.

In still some other examples of the present disclosure, the exhibition information provision system 100 can display the user-identified image of a user and the image captured by the first imaging device with which the user is identified on the visitor monitoring screen.

The exhibition information provision system 100 according to another example of the present disclosure can determine admission of the user terminal 300 to the exhibition hall, based on a determination that the admission ticket corresponding to the user terminal 300 is valid.

The exhibition information provision system 100 according to another example of the present disclosure can transmit information of the user corresponding to the user terminal 300 to the spot management terminal 500 at a first spot in response to a determination that the location of the user terminal 300 has reached the first spot, which is one of a plurality of spots existing in the exhibition hall, and that a first condition is satisfied, which will be described in detail later.

The exhibition information provision system 100 according to another example of the present disclosure can obtain visit information of the user terminal 300 for each of the plurality of spots in the exhibition hall as a result of tracking the location of the user terminal 300 within the exhibition hall. Here, a method by which the exhibition information provision system 100 tracks the location of the user terminal 300 within the exhibition hall is not limited to any of the indoor positioning methods known in the related art.

In the examples of the present disclosure, the exhibition information provision system 100 can calculate the usage time and wait time of the user terminal 300 at each of the plurality of spots, which will be described in detail later.

In other examples of the present disclosure, the usage time of the user terminal 300 at a specific spot may refer to the time for which the user terminal 300 has stayed within a first area inside the specific spot.

In still some other examples of the present disclosure, the waiting time of the user terminal 300 at a specific spot may refer to the time for which a user of the user terminal 300 has waited to use the specific spot. The exhibition information provision system 100 can identify whether the user terminal 300 has stayed within a second area outside of the specific spot and, based on a determination that the user terminal 300 is located in the first area of the specific spot after a certain period of time, determine the time for which the user terminal 300 has stayed within the second area of the specific spot to be the waiting time of the user terminal 300 at the specific spot, which will be described in detail later.

In still some other examples of the present disclosure, the exhibit information provision system 100 may be a system that stores map information for a specific exhibit hall. That is, based on map information for the specific exhibition hall, the exhibition information provision system 100 can identify whether the space in which the user terminal 300 is located is a specific element of the specific exhibition hall.

So far, the configuration and operation of the exhibition information provision system 100 and an exemplary environment to which the exhibition information provision system 100 can be applied have been described with reference to FIG. 1. The exhibition information provision system 100 and the gate 200 may be understood as operating according to a server-client model. However, in the examples, the system may be configured on a standalone client without the need for a server. In this case, the operation performed by the exhibition information provision system 100 may be understood as being performed at the gate 200.

The examples described above should be understood in all respects as illustrative and not restrictive. In addition, the configuration and operation of the exhibition information provision system 100 according to the present example may be supplemented by some examples described later.

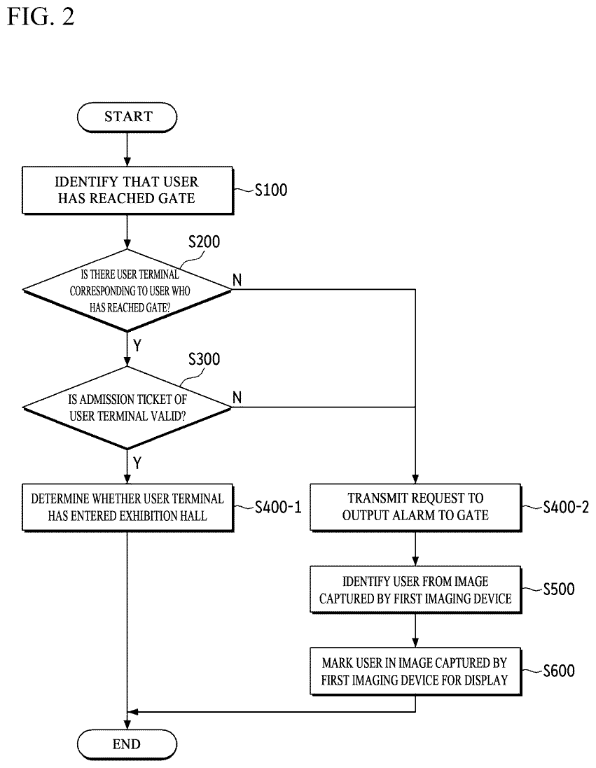

Hereinafter, a method for monitoring visitors according to another example of the present disclosure will be described with reference to FIGS. 2 to 5. The steps to be described in the flowcharts below may be understood as being performed by the exhibition information provision system 100 described with reference to FIG. 1 unless otherwise specified. In addition, it goes without saying that the technical idea that can be understood from the examples described above with reference to FIG. 1 can be obviously applied to the method for monitoring visitors according to the present example.

FIG. 2 is a flowchart of a method for monitoring visitors according to one example of the present disclosure.

In step S100, illustrated in FIG. 2, the exhibition information provision system 100 can identify that the user terminal 300 has approached within a predefined range of the gate 200.

Hereinafter, for the purposes of the present disclosure, visitors to the exhibition hall are collectively referred to as users.

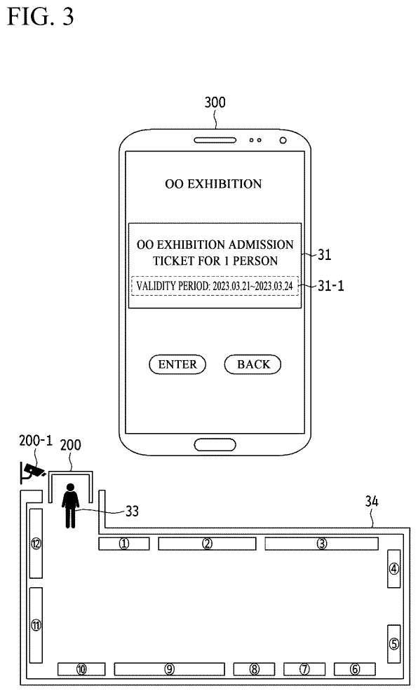

In the examples related to step S100, referring to FIG. 3, the exhibition information provision system 100 can identify whether the user terminal 300 corresponding to a first user 33 has reached at the gate based on a determination that the gate imaging device 200-1 included in the gate 200 has identified the first user 33.

In step S200, the exhibition information provision system 100 can determine whether the user terminal 300 corresponding to a user who has reached the gate 200 is present.

In the examples related to step S200, referring to FIG. 3, the exhibition information provision system 100 can identify the first user 33 present at the gate 200 by using a user-identified image of the first user 33 captured by the gate imaging device 200-1, and can determine the user terminal 300 located at the gate 200 to be the user terminal 300 of the first user 33, based on a determination that the user terminal 300 is present at the location of the gate 200.

In the examples related to step S200, referring to FIG. 3, the exhibition information provision system 100 can identify the first user 33 present at the gate 200 by using the user-identified image of the first user 33 captured by the gate imaging device 200-1, but determine that no user terminal 300 corresponding to the first user 33 is present at the location of the gate 200, based on a determination that no user terminal 300 is present at the location of the gate 200. In addition, the exhibition information provision system 100 can perform the steps S400-2 illustrated in FIG. 2 based on a determination that the user terminal 300 corresponding to the first user 33 is not present, which will be described later.

In step S300, the exhibition information provision system 100 can determine whether the admission ticket corresponding to the user terminal 300 is valid.

In step S400-1, the exhibition information provision system 100 can determine a valid admission of the user terminal 300 to the exhibition hall, based on a determination that the admission ticket corresponding to the user terminal 300 is valid.

In step S400-2, the exhibition information provision system 100 can transmit a request to output an alarm to the gate 200 when an admission ticket corresponding to the user terminal 300 is invalid.

In step S500, when the admission ticket corresponding to the user terminal 300 is identified as invalid, the exhibition information provision system 100 can identify the user corresponding to the user terminal 300 by using visual feature information of the user corresponding to the user terminal 300 in the image captured by the first imaging device 400 capable of capturing an image corresponding to the position of the user terminal 300 among the plurality of imaging devices in the exhibition hall, based on the position information of the user terminal 300.

In step S600, the exhibition information provision system 100 can mark the user corresponding to the user terminal 300 in the image captured by the first imaging device 400 and display the user on the visitor monitoring screen.

In the examples related to step S300, referring to FIG. 3, the exhibition information provision system 100 can determine that a first admission ticket 31 is valid based on a determination that validity period information 31-1 of the first admission ticket 31 corresponding to the user terminal 300 of the first user 33 is within a valid range.

In other examples related to step S300, referring to FIG. 3, the user terminal 300 can transmit a request to the exhibition information provision system 100 to determine whether the admission ticket is valid, based on a determination that the first user 33 has performed an input on an admission button 42 displayed on the user terminal 300.

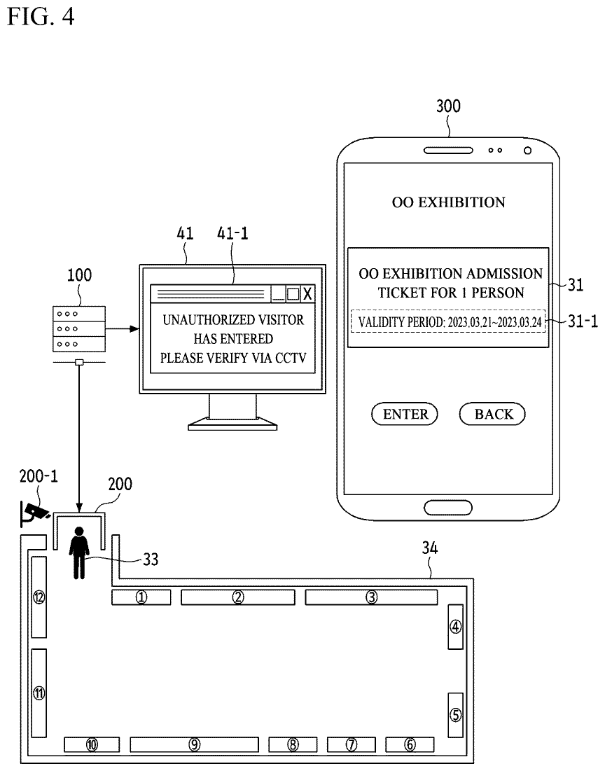

In still some other examples related to step S300, referring to FIG. 4, the exhibition information provision system 100 can determine that the first admission ticket 31 is invalid based on a determination that the validity period information 31-1 of the first admission ticket 31 corresponding to the user terminal 300 of the first user 33 is not within the valid range.

In still some other examples related to step S300, referring to FIG. 3, the exhibition information provision system 100 can modify whether the first admission ticket 31 corresponding to the first user terminal 300 has expired, based on information that the user terminal 300 of the first user 33 has passed through the gate 200 and is located within a first exhibition hall 34.

In still some other examples related to step S300, referring to FIG. 3, the exhibition information provision system 100 can obtain a user-identified image of the first user 33 from the user-identified image of the first user 33 captured by the gate imaging device 200-1 of the gate 200 when the first admission ticket 31 corresponding to the user terminal 300 of the first user 33 is determined to be invalid, and obtain visual feature information of the first user 33 from the user-identified image of the first user 33.

According to the present example, the effect of protecting the personal information of users with valid admission tickets can be achieved by not imaging people with valid admission tickets.

In still some other examples related to step S300, referring to FIG. 3, the exhibition information provision system 100 can map and store the identifier information of the user terminal 300 of the first user 33 and the visual feature information of the first user 33, based on the visual feature information of the first user 33 and the location information of the user terminal 300 of the first user 33.

According to the present example, the exhibition information provision system 100 can track the location of the user terminal 300 carried by a unauthorized visitor who has entered the exhibition hall with an invalid admission ticket to track the location of the unauthorized visitor in real time, and can specify a camera within the exhibition hall that is capable of imaging the location of the unauthorized visitor.

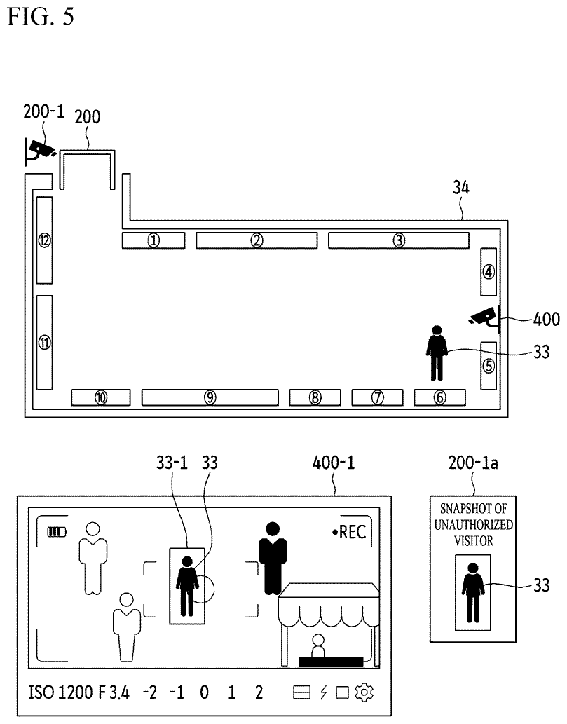

Hereinafter, a case where the exhibition information provision system 100 identifies that the first admission ticket 31 is invalid will be described with reference to FIGS. 4 and 5.

In some examples related to steps S300 and S400-2, when the first admission ticket 31 is determined to be invalid, the exhibition information provision system 100 can display an alarm 41-1 related to the entry of an unauthorized visitor on a display device 41. Then, in step S400-2, the exhibition information provision system 100 can transmit a request to the gate 200 to output an alarm in response to a determination that the first admission ticket 31 is invalid.

In some examples related to steps S300 and S500, referring to FIG. 5, when it is determined that the first admission ticket 31 corresponding to the user terminal 300 corresponding to the first user 33 is invalid, the exhibition information provision system 100 can identify the first user 33 by using visual feature information of the first user 33 in an image 400-1 captured by the first imaging device 400 capable of capturing an image corresponding to the position of the user terminal 300 of the first user 33 among a plurality of imaging devices in the first exhibition hall 34, based on the location information of the user terminal 300 of the first user 33.

In the examples related to steps S300 and S600, referring to FIGS. 4 and 5, as the first admission ticket 31 of the user terminal 300 corresponding to the first user 33 is determined to be invalid, the exhibition information provision system 100 can add a mark 33-1 on the area identified as the first user 33 in the image 400-1 captured by the first imaging device 400 to display the image on the visitor monitoring screen.

In still some other examples involving steps S300 and S600, referring to FIG. 5, the exhibition information provision system 100 can display a user-identified image 200-1a of the first user 33 captured by the gate imaging device 200-1 and the image 400-1 captured by the first imaging device 400 together on the visitor monitoring screen.

According to the present example, when a user other than an unauthorized visitor is misidentified in the image captured by the imaging device 400, the exhibition information provision system 100 is capable of allowing the user of the exhibition information provision system 100 to directly identify an unauthorized visitor in the image.

In still another examples related to steps S300 and S600, referring to FIGS. 4 and 5, when the first admission ticket 31 of the user terminal 300 corresponding to the first user 33 is determined to be invalid, after the first user 33 is identified at the location of the first imaging device 400, as the user terminal 300 of the first user 33 moves, the exhibition information provision system can add the mark 33-1 on the area identified as the first user 33 in an image (not illustrated) captured by a second imaging device (not illustrated) located in a different position from the first imaging device 400 in the first exhibition hall 34 and display the image on the screen.

According to the present example, the exhibition information provision system 100 can achieve the effect of automatically providing information about the location of an unauthorized visitor present in the exhibition hall to an administrator of the exhibition information provision system 100.

So far, a method for providing exhibition information according to one example of the present disclosure has been described with reference to FIGS. 2 to 5. The examples described above should be understood in all respects as illustrative and not restrictive.

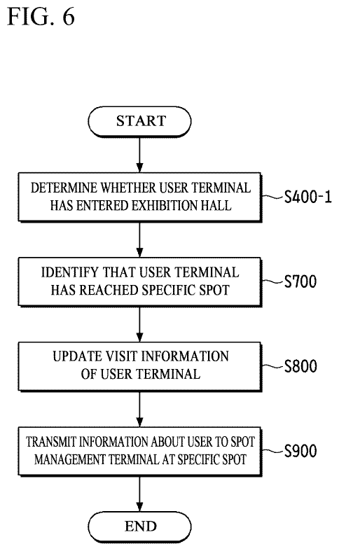

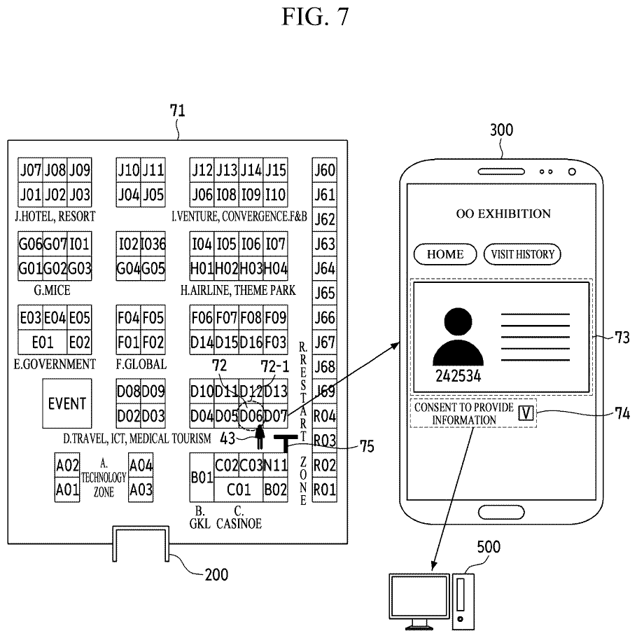

Hereinafter, a method for providing exhibition information according to another example of the present disclosure will be described with reference to FIGS. 6 and 7. The steps to be described in the flowcharts below may be understood as being performed by the exhibition information provision system 100 described with reference to FIG. 1 unless otherwise specified. In addition, it goes without saying that the technical idea that can be understood from the examples described above with reference to FIG. 1 can be obviously applied to the method for providing exhibition information according to the present example.

In step S400-1, illustrated in FIG. 6, the exhibition information provision system 100 can determine the user terminal 300 entering the exhibition hall. Some examples related to step S400-1 will be clearly understood with reference to the examples related to step S400-1 described with reference to FIG. 2.

Next, in step S700, the exhibition information provision system 100 can identify whether the user terminal 300 has reached a specific spot.

In step S800, the exhibition information provision system 100 can update visit information of the user terminal 300 in response to identifying that the user terminal 300 has reached the specific spot. Here, the visit information of the user terminal 300 may include identifier information for the spot visited by the user terminal 300 and information on the time for which the user terminal 300 has stayed at each spot.

In the examples related to step S800, the exhibition information provision system 100 can update the visit information of the user terminal 300 when the user terminal 300 stays within the first area within a specific spot for a time equal to or more than a threshold.

In the examples related to steps S700 and S800, referring to FIG. 7, when the user terminal 300 of a second user 43 determined to have entered a second exhibition hall 71 is located in a first area 72-1 inside a first spot 72 of the second exhibition hall 71, the exhibition information provision system 100 can identify that the user terminal 300 of a second user 43 has reached the first spot 72 of the second exhibition hall 71.

And, when the exhibition information provision system 100 identifies that the user terminal 300 of the second user 43 has stayed within the first area 72-1 of the first spot 72 of the second exhibition hall 71 for a time period longer than a threshold, the visit information of the user terminal 300 can be updated to include identifier information for the first spot 72 and information on the time for which the user terminal 300 of the second user 43 has stayed in the first spot 72.

In step S900, the exhibition information provision system 100 can transmit information of the user corresponding to the user terminal 300 to the spot management terminal 500 at a specific spot when the first condition is satisfied.

In the examples related to step S900, the first condition may be that the user terminal 300 stays in the first area inside a specific spot or the second area outside the specific spot for more than a reference time. The second area outside the specific spot will be described later.

In still another examples related to step S900, the first condition may be that the specific spot is one of the spots defined by the user of the user terminal 300.

For example, referring to FIG. 7, when the first spot 72 of the second exhibition hall 71 is not a spot predefined on the user terminal 300 by the second user 43, the exhibition information provision system 100 may not transmit information 73 of the second user 43 to the spot management terminal 500 at the first spot 72 even though the user terminal 300 of the second user 43 stays in the first area 72-1 of the first spot 72 of the second exhibition hall 71 for more than a reference time.

According to one example, visitors to the exhibition hall can only provide their information to the booth they wish to use. Therefore, the effect of protecting visitors' personal information can be achieved by preventing personal information from being provided to unnecessary booths.

In still some other examples related to step S900, the first condition may be that the information of the user of the user terminal 300 satisfies a condition predefined by the spot management terminal 500 at a specific spot.

For example, referring to FIG. 7, when the gender information of the second user 43 is male, the exhibition information provision system 100 may not transmit the information of the second user 43 to the spot management terminal 500 at the first spot 72, based on the information that the spot management terminal 500 at the first spot 72 in the second exhibition hall 71 is preset to receive only information of female users even though the user terminal 300 of the second user 43 stays in the first area 72-1 of the first spot 72 of the second exhibition hall 71 for more than a reference time.

According to the present example, the operator of each booth in the exhibition hall can select only the information of the user population for which the service provided by the booth is deemed to be valid.

In still some other examples related to step S900, as a result of tracking the location of the user terminal 300, when the movement of the user terminal 300 corresponds to a predefined gesture, the exhibition information provision system 100 may not transmit the user information 73 of the user terminal 300 to the spot management terminal at a specific spot.

For example, referring to FIG. 7, as a result of tracking the location of the user terminal 300 of the second user 43, when a trajectory 75 along which the user terminal 300 of the second user 43 moves corresponds to a ‘T’ shape, the exhibition information provision system 100 may not transmit the information 73 of the second user 43 to the spot management terminal 500 at the first spot 72 even though the user terminal 300 of the second user 43 stays in the first area 72-1 of the first spot 72 in the second exhibition hall 71 for more than a reference time.

According to the present example, visitors to the exhibition hall can refuse to provide information by using a sign that is unknown to the booth operator, thereby protecting their personal information without visually expressing their intention to the booth operator.

In still some other examples related to step S900, the user information corresponding to the user terminal 300 may be information previously transmitted by the user terminal 300 to the exhibition information provision system 100 before entering the exhibition hall, in some other examples, the user information corresponding to the user terminal 300 may be information stored only in the user terminal 300. In the above case, the operation of transmitting user information to the spot management terminal 500 can be understood as being performed by the user terminal 300.

In still some other examples related to step S900, referring to FIG. 7, when the user terminal 300 of the second user 43 stays in the first area 72-1 of the first spot 72 in the second exhibition hall 71 for a time equal to or more than a threshold, the exhibition information provision system 100 can transmit the information 73 of the second user 43 stored in the user terminal 300 to the spot management terminal 500 at the first spot 72.

In still some other examples related to step S900, referring to FIG. 7, when the user terminal 300 of the second user 43 is the user terminal 300 with a consent setting 74 already enabled to provide the information 73 of the second user 43 to the spot management terminal 500 at the spot to be visited by the second user 43, and when it is identified that the user terminal 300 of the second user 43 has stayed in the first area 72-1 of the first spot 72 in the second exhibition hall 71 for a time equal to or more than a threshold, the exhibition information provision system 100 can transmit the information 73 of the second user 43 stored in the user terminal 300 to the spot management terminal 500 at the first spot 72 in the second exhibition hall 71.

According to the present example, in exhibition halls such as job fairs where visitor information is required to provide services at exhibition booths, the effect of reducing the time cost of directly entering user information into the booth's management terminal can be achieved.

So far, a method for providing exhibition information according to another example of the present disclosure has been described with reference to FIGS. 6 and 7. The examples described above should be understood in all respects as illustrative and not restrictive.

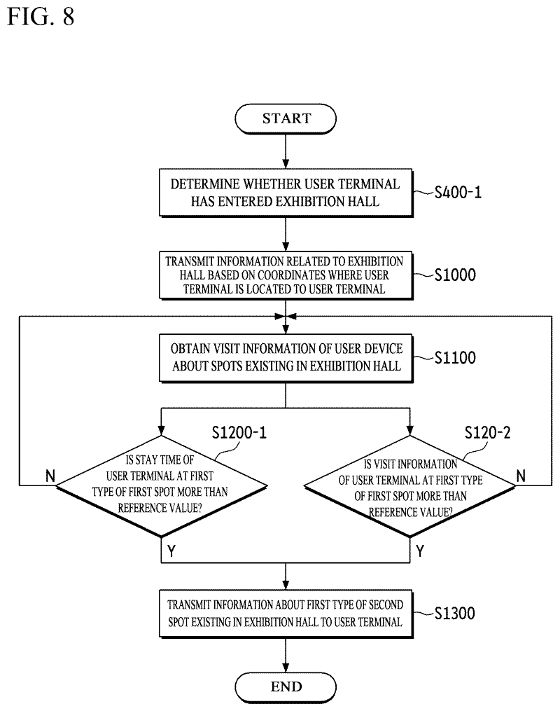

Hereinafter, a method for providing exhibition information according to another example of the present disclosure will be described with reference to FIGS. 8 to 13. The steps to be described in the flowcharts below may be understood as being performed by the exhibition information provision system 100 described with reference to FIG. 1 unless otherwise specified. In addition, it goes without saying that the technical idea that can be understood from the examples described above with reference to FIG. 1 can be obviously applied to the method for providing exhibition information according to the present example.

In step S400-1, illustrated in FIG. 8, the exhibition information provision system 100 can determine the user terminal 300 entering the exhibition hall. Some examples related to step S400-1 will be clearly understood with reference to the examples related to step S400-1 described with reference to FIG. 2.

In step S1000, the exhibition information provision system 100 can transmit information related to an exhibition hall existing within a predefined range of the user terminal 300 to the user terminal, based on the coordinates where the user terminal 300 is located.

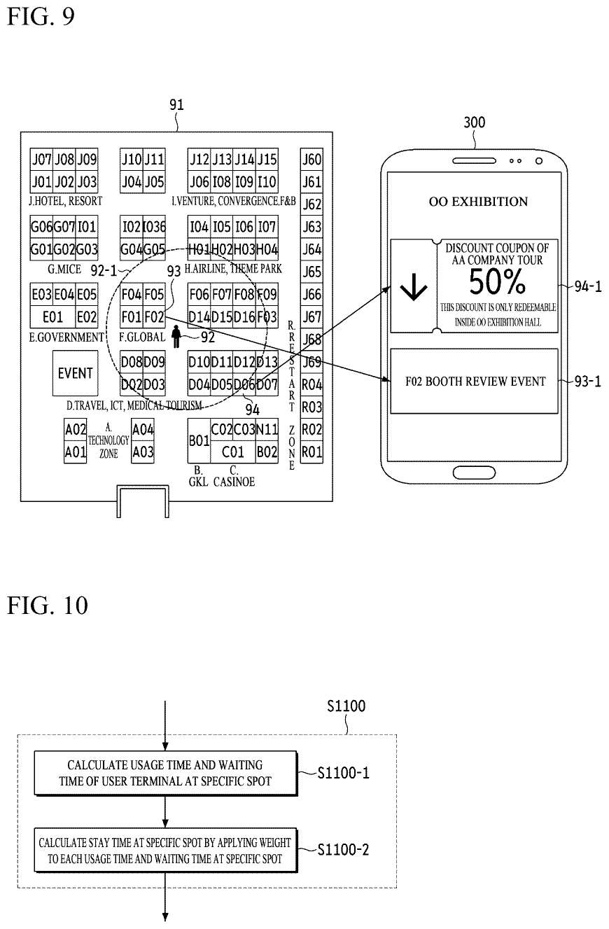

In the examples related to step S1000, referring to FIG. 9, to the user terminal 300, the exhibition information provision system 100 can transmit information related to one or more spots existing within a predefined range 92-1 of a first coordinates within a third exhibition hall 91 where the user terminal 300 of a third user 92 is located.

In other examples related to step S1000, for example, referring to FIG. 9, information related to one or more spots existing within the predefined range 92-1 of the first coordinates in the third exhibition hall 91 includes event information 93-1 being implemented in a fifth spot 93 existing within the predefined range 92-1 of the first coordinates and information of a coupon 94-1 available at a first spot 94 existing within the predefined range 92-1 of the first coordinates

In step S1100, the exhibition information provision system 100 can obtain visit information of the user terminal 300 at one or more spots existing in the exhibition hall. Some examples related to step S1100 can be clearly understood by referring to the examples related to step S800 described with reference to FIG. 6 above.

In the examples related to step S1100, the visit information of the user terminal 300 at one or more spots existing in the exhibition hall may include information on the stay time of the user terminal 300 at each of the one or more spots.

Hereinafter, step S1100 will be described in detail with reference to FIGS. 10 to 12.

In step S1100-1 illustrated in FIG. 10, the exhibition information provision system 100 can calculate the usage time and waiting time at a particular spot of the user terminal 300.

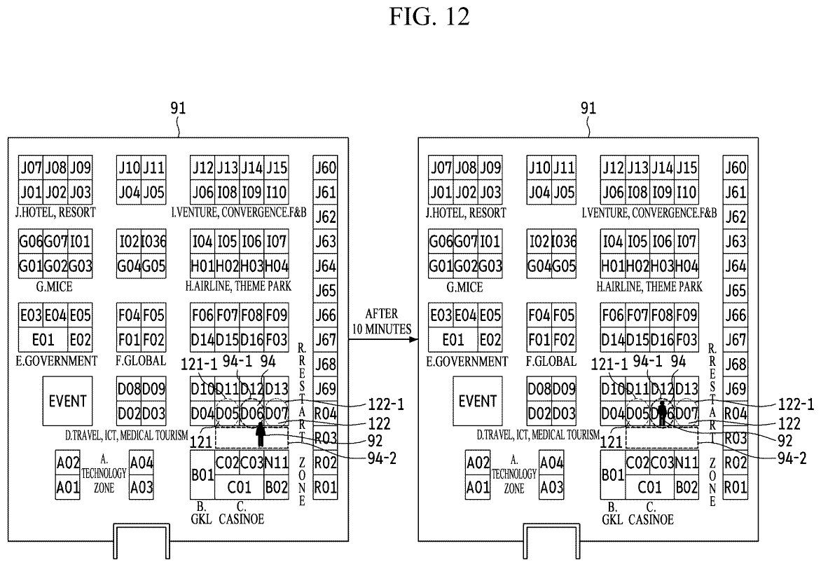

In the examples related to step S1100-1, referring to FIG. 12, the usage time of the user terminal 300 of the third user 92 at the first spot 94 of the third exhibition hall 91 may refer to the time for which the user terminal 300 of the third user 92 has stayed within a first area 94-1 inside the first spot 94.

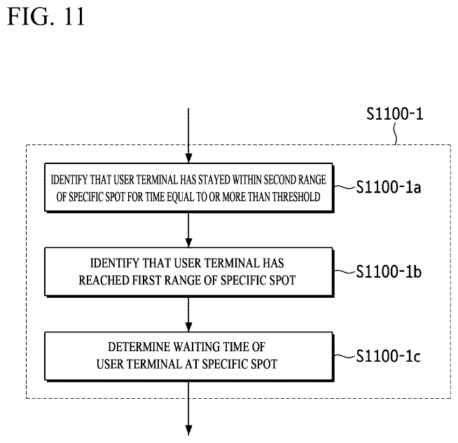

Hereinafter, step S1100-1 will be described in detail with reference to FIGS. 11 and 12.

In step S1100-1a, the exhibition information provision system 100 can identify that the user terminal 300 has stayed within the second area outside the specific spot for a time equal to or more than a threshold.

In some examples related to step S1100-1a, the exhibition information provision system 100 can begin counting the waiting time of the user terminal 300 at a specific spot as it is identified the user terminal 300 has stayed within the second area of a specific spot for a time equal to or more than a threshold.

For example, referring to FIG. 12, the exhibition information provision system 100 can begin counting the waiting time of the user terminal 300 of the third user 92 at the first spot 94 as it is identified that the user terminal 300 of the third user 92 has stayed in a second area 94-2 outside the first spot 94 in the third exhibition hall 91 for more than a threshold.

In step S1100-1b, when the user terminal 300 reaches a first area of a specific spot, in step S1100-1c, the exhibition information provision system 100 can determine a time for which the user terminal 300 has stayed in the second area of a specific spot to be the waiting time of the user terminal 300 at the specific spot.

In some examples related to step S1100-1b, the second area of the specific spot may refer to a predefined adjacent area of the first area within the specific spot.

For example, as illustrated in FIG. 12, the first area 94-1 of the first spot 94 in the third exhibition hall 91 may refer to the space inside the first spot 94, and the second area 94-2 of the first spot 94 in the third exhibition hall 91 may refer to an area with a predefined size outside the first spot 94, which is adjacent to the first area 94-1 of the first spot 94 in the third exhibition hall 91.

In some examples related to steps S1100-1b and S1100-1c, referring to FIG. 12, after the user terminal 300 of the third user 92 has stayed in the second area 94-2 of the first spot 94 in the third exhibition hall 91 for 10 minutes, and has reached the first area 94-1 of the first spot 94, the exhibition information provision system 100 can determine the waiting time the user terminal 300 of the third user 92 at the first spot 94 to be 10 minutes.

In some other examples related to steps S1100-1b and S1100-1c, referring to FIG. 12, assuming that the second area 94-2 of the first spot 94 in the third exhibition hall 91 and the second area (not illustrated) of the second spot 122, which is an adjacent spot of the first spot 94, are partially overlapped, after the user terminal 300 of the third user 92 has stayed in the area where the second area 94-2 of the first spot 94 and the second area 122 of the second spot (not shown) are overlapped for 10 minutes, and has reached the first area 122-1 of the second spot 122, the exhibition information provision system 100 can determine that the waiting time of the user terminal 300 of the third user 92 at the second spot 122 to be 10 minutes.

In still some other examples related to steps S1100-1b and S1100-1c, referring to FIG. 12, assuming that the second area 94-2 of the first spot 94 in the third exhibition hall 91 and the second area (not illustrated) of the second spot 122, which is an adjacent spot of the first spot 94, are partially overlapped, after the user terminal 300 of the third user 92 has stayed in the area where the second area 94-2 of the first spot 94 and the second area 122 of the second spot (not illustrated) are overlapped for 10 minutes, and has reached the first area 122-1 of the second spot 122, the exhibition information provision system 100 can determine that the waiting time of the user terminal 300 of the third user 92 at the second spot 122 to be 10 minutes.

Hereinafter, description will continue with reference to FIG. 10.

In step S1100-2, the exhibition information provision system 100 can calculate the stay time at a specific spot by applying different weights to each of the usage time and waiting time of the user terminal 300 at the specific spot.

In some examples related to step S1100-2, the exhibition information provision system 100 can apply the first weight to the usage time of the user terminal 300 at a specific spot, apply the second weight to the waiting time of the user terminal 300 at the specific spot, and add the weighted usage time and waiting time up to determine the stay time of the user terminal 300 at the specific spot.

In some other examples related to step S1100-2, the first weight may be lower than the second weight, but in still some other examples, the first weight may be higher than the second weight.

When a user waits for a long time to use a specific booth in the exhibition hall, there is a high probability that the user has a high preference for that specific booth. Thus, according to the present example, by predicting that a user has a high preference for a booth that the user has waited a long time to use, the effect of accurately predicting the preference information of the user for each of a plurality of booths in the exhibition hall can be achieved. Further, according to the present example, based on the above predicted preference information of the user for each of the plurality of booths in the exhibit hall, of course, other booths in the exhibition hall that suit the user's preferences can be recommended.

Hereinafter, description will continue with reference to FIG. 8.

In step S1200-1, the exhibition information provision system 100 can determine whether the stay time of the user terminal 300 at a first type of the specific spot calculated in step S1100-2 is equal to or more than a reference value.

In step S1200-2, the exhibition information provision system 100 can determine whether the visit information of the user terminal 300 at a plurality of first type of spots is more than a reference value.

Then, in step S1300, the exhibition information provision system 100 can transmit information about a first type of other spots existing within the exhibition hall to the user terminal 300, based on a determination that the stay time of the user terminal 300 at a first type of a specific spot is equal to or more than a reference value, or that the visit information of the user terminal 300 at a first type of a plurality of spots is equal to or more than a reference value.

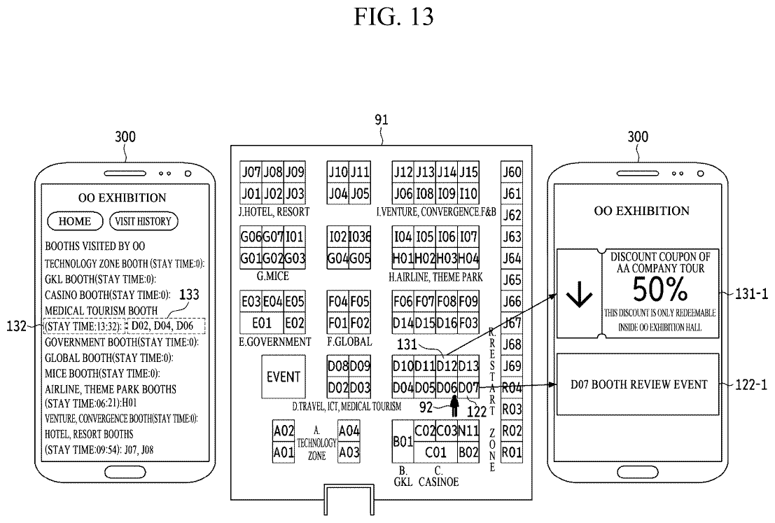

In some examples related to steps S1200-1, S1200-2, and S1300, referring to FIG. 13, based on a determination that stay time information 132 of the user terminal 300 of the third user 92 at a medical tourism type of booth is more than a reference value, the exhibition information provision system 100 can transmit event information 122 related to the second spot 122 of the third exhibition hall 91, which is a booth not included in visited booth information 133 of the user terminal 300 of the third user 92 for a medical tourism type of booth and coupon information 131-1 related to a fourth spot 131, to the user terminal 300.

In some other examples related to steps S1200-1, S1200-2, and step S1300, referring to FIG. 13, based on a determination that stay time information 132 of the user terminal 300 of the third user 92 at a medical tourism type of booth is more than a reference value, based on a determination that the third user 92 has visited the medical tourism type of booth number of times more than a reference value when referring to the visited booth information 133 of the user terminal 300 of the third user 92 for the medical tourism type of booth, the exhibition information provision system 100 can transmit the event information 122 related to the second spot 122 of the third exhibition hall 91, which is a booth not included in the visited booth information 133 of the user terminal 300 of the third user 92 for a medical tourism type of booth and the coupon information 131-1 related to the fourth spot 131, to the user terminal 300.

According to the present example, the exhibition information provision system 100 can achieve the effect of automatically providing visitors with information related to booths in the exhibition hall suitable for each visitor's preferences.

So far, a method for providing exhibition information according to another example of the present disclosure has been described with reference to FIGS. 8 to 13. The examples described above should be understood in all respects as illustrative and not restrictive.

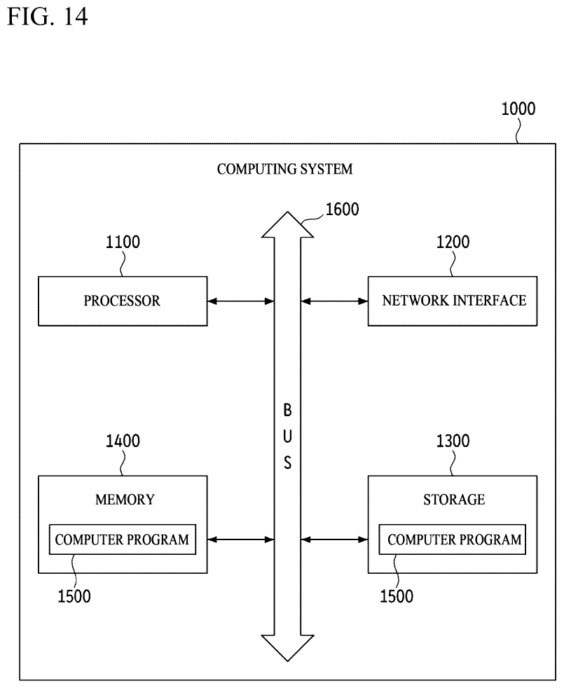

FIG. 14 is a hardware configuration diagram of a computing system 1000 according to the examples of the present disclosure. The computing system 1000 of FIG. 14 may refer to, for example, the exhibition information provision system 100 described with reference to FIG. 1. In another example, the computing system 1000 of FIG. 14 may include one or more processors 1100, a system bus 1600, a communication interface 1200, a memory 1400 for loading a computer program 1500 executed by the processors 1100, and a storage 1300 for storing the computer program 1500.

The processor 1100 controls the overall operation of each component of the computing system 1000. The processor 1100 may perform an operation on at least one application or program for executing a method/operation according to various examples of the present disclosure. The memory 1400 stores various data, commands, and/or information. The memory 1400 may load one or more computer programs 1500 from the storage 1300 to execute methods/operations according to various examples of the present disclosure. The system bus 1600 provides a communication function between the components of the computing system 1000. The communication interface 1200 supports Internet communication of the computing system 1000. The storage 1300 may non-temporarily store one or more computer programs 1500. The computer program 1500 may comprise one or more instructions in which methods/operations according to various examples of the present disclosure are implemented. Once the computer program 1500 is loaded into the memory 1400, the processor 1100 may execute the one or more instructions to perform methods/operations according to various examples of the present disclosure.

In the examples, the computing system 1000 described with reference to FIG. 14 may be configured by using one or more physical servers comprised a server farm based on cloud technology such as virtual machines. In this case, at least some of the components illustrated in FIG. 14, such as the processor 1100, memory 1400, and storage 1300, may be virtual hardware, and the communication interface 1200 may also comprise virtualized networking elements, such as virtual switches.

The computer program 1500 according to some examples of the present disclosure may include instructions to perform an operation of identifying a first user terminal approaching within a predefined range of a gate, an operation of identifying whether a first admission ticket corresponding to the first user terminal is valid in response to identifying the first user terminal approaching the gate, an operation of obtaining visual feature information of a first user from a user-identified image of the first user of the first user terminal captured by an imaging device of the gate when the first admission ticket is identified as invalid, an operation of mapping identifier information of the first user terminal and the visual feature information of the first user based on the obtained visual feature information of the first user and location information of the first user terminal, and an operation of displaying an alarm on a visitor monitoring screen when the first admission ticket is identified as invalid.

So far, various examples of the present disclosure and effects according to the examples have been mentioned with reference to FIGS. 1 to 14. The effects according to the technical idea of the present disclosure are not limited to the effects mentioned above, and other effects not mentioned will be clearly understood by those skilled in the art from the following description.

The technical idea of the present disclosure described so far may be implemented as computer-readable code on a computer-readable medium. The computer program recorded in the computer-readable recording medium may be transmitted to another computing device through a network such as the Internet and installed in the other computing device, and thus may be used in the other computing device.

Although the operations are shown in a particular order in the drawings, it should not be understood which the operations must be executed in the particular order shown, in sequential order, or which all shown operations must be executed in order to achieve the desired results. In certain situations, multitasking and parallel processing may be advantageous. Although examples of the disclosure have been described above with reference to the accompanying drawings, those skilled in the art to which the disclosure pertains may understand which the disclosure may be implemented in other specific forms without changing the technical idea or essential features. Therefore, it should be understood which the examples described above are exemplary in all aspects and are not limited thereto. The protection scope of the present invention should be interpreted by the following claims, and all technical ideas within the scope equivalent thereto should be interpreted as being comprised the scope of rights of the technical idea defined by the present disclosure.

1. A method for monitoring visitors, which is performed by a computing system, the method comprising:
identifying a first user terminal approaching within a predefined range of a gate;
identifying whether a first admission ticket corresponding to the first user terminal is valid in response to identifying the first user terminal approaching the gate;
obtaining visual feature information of a first user from a user-identified image of the first user of the first user terminal captured by an imaging device of the gate when the first admission ticket is identified as invalid;
mapping identifier information of the first user terminal and the visual feature information of the first user based on the obtained visual feature information of the first user and location information of the first user terminal; and
displaying an alarm on a visitor monitoring screen when the first admission ticket is identified as invalid, wherein displaying the alarm on the visitor monitoring screen includes:
identifying the first user by using the visual feature information of the first user in an image captured by a first imaging device capable of capturing the image corresponding to a location of the first user terminal among a plurality of imaging devices in an exhibition hall, based on the location information of the first user terminal,
marking the first user in the image captured by the first imaging device and displaying the image on the visitor monitoring screen, and
displaying the user-identified image of the first user and the image captured by the first imaging device together on the visitor monitoring screen,
the user-identified image is captured when the first admission ticket is identified as invalid by the imaging device of the gate,
identifying whether the first admission ticket is valid includes
determining whether a predefined parameter value included in the first admission ticket is within a valid range.

2. A method for monitoring visitors, which is performed by a computing system, the method comprising:
identifying a first user terminal entering an exhibition hall; and
transmitting information of a first user corresponding to the first user terminal to a spot management terminal at a first spot in response to identifying that a first condition is satisfied, when a location of the first user terminal reaches the first spot that is one of a plurality of spots existing in the exhibition hall.

3. The method for providing exhibition information according to claim 1, wherein
identifying the first user terminal entering the exhibition hall includes:
identifying the first user terminal approaching within the predefined range of the gate,
identifying whether the first admission ticket corresponding to the first user terminal is valid in response to identifying the first user terminal approaching the gate, and
determining the first user terminal entering the exhibition hall when the first admission ticket is identified as valid.

4. The method for providing exhibition information according to claim 2, wherein
the first condition is that the first user terminal stays in a first area or a second area of the first spot for more than a reference time.

5. The method for providing exhibition information according to claim 2, wherein
the first condition is that the first spot is one of the spots predefined by the first user.

6. The method for providing exhibition information according to claim 2, wherein
the first condition is that the information of the first user satisfies conditions predefined by the spot management terminal at the first spot.

7. The method for providing exhibition information according to claim 1, wherein
not transmitting the information of the first user to the spot management terminal at the first spot when movement of the first user terminal corresponds to a predefined gesture as a result of tracking the location of the first user terminal.

8. A method for monitoring visitors, which is performed by a computing system, the method comprising:
obtaining visit information of a first user terminal for a plurality of spots existing in an exhibition hall, in which the visit information of the first user terminal includes a time for which the first user terminal has stayed at each of a plurality of spots; and
transmitting information about a first type of a second spot existing in the exhibition hall to the first user terminal based on a determination that a time for which the first user terminal has stayed at a first type of a first spot is equal to or more than a reference value, wherein
the visit information of the first user terminal is obtained as a result of tracking a location of the first user terminal within the exhibition hall.

9. The method for providing exhibition information according to claim 8, wherein
obtaining the visit information of the first user terminal for the plurality of spots existing in the exhibition hall includes:
calculating each of a usage time and a waiting time of the first user terminal at the first spot, in which the usage time of the first user terminal at the first spot is a time for which the first user terminal has stayed inside a first area inside the first spot, and
applying a first weight to the usage time of the first user terminal at the first spot and applying a second weight to the waiting time at the first spot to determine a time for which the first user terminal has stayed at the first spot.

10. The method for providing exhibition information according to claim 9, wherein
calculating the waiting time of the first user terminal at the first spot includes:
identifying that the first user terminal staying within a second area outside the first spot for a time equal to or more than a threshold, and
determining a time for which the first user terminal has stayed in the second area of the first spot as the waiting time of the first user terminal at the first spot when it is identified that the first user terminal has reached the first area of the first spot, and
the second area is at least a portion of a predefined adjacent area of the first spot.

11. The method for providing exhibition information according to claim 10, further comprising:
determining that the first user terminal has not stayed at the first spot when the first user terminal has reached the first area of the adjacent spot corresponding to the first spot.

12. The method for providing exhibition information according to claim 8, wherein
transmitting information about a first type of a third spot to the first user terminal when the visit information of the first user terminal includes the visit information about the first type of the second spot more than a reference value, wherein
the first type of the third spot is a spot that is not included in the visit information of the first user terminal.

13. A exhibition information provision system comprising:
one or more processors; and
a memory that stores a computer program executed by the one or more processors, wherein
the computer program is stored on a computer-readable recording medium to execute:
identifying a first user terminal approaching within a predefined range of a gate;
identifying whether a first admission ticket corresponding to the first user terminal is valid in response to identifying the first user terminal approaching the gate;
obtaining visual feature information of a first user from a user-identified image of the first user of the first user terminal captured by an imaging device of the gate when the first admission ticket is identified as invalid;
mapping identifier information of the first user terminal and the visual feature information of the first user based on the obtained visual feature information of the first user and location information of the first user terminal; and
displaying an alarm on a visitor monitoring screen when the first admission ticket is identified as invalid,
displaying the alarm on the visitor monitoring screen includes:
identifying the first user by using the visual feature information of the first user in an image captured by a first imaging device capable of capturing the image corresponding to a location of the first user terminal among a plurality of imaging devices in an exhibition hall, based on the location information of the first user terminal,
marking the first user in the image captured by the first imaging device and displaying the image on the visitor monitoring screen, and
displaying the user-identified image of the first user and the image captured by the first imaging device together on the visitor monitoring screen,
the user-identified image is captured when the first admission ticket is identified as invalid by the imaging device of the gate,
identifying whether the first admission ticket is valid includes
determining whether a predefined parameter value included in the first admission ticket is within a valid range.

14. An exhibition information provision system comprising:
one or more processors; and
a memory that stores a computer program executed by the one or more processors, wherein
the computer program is stored on a computer-readable recording medium to execute:
identifying a first user terminal entering an exhibition hall; and
transmitting information of a first user corresponding to the first user terminal to a spot management terminal at a first spot in response to identifying that a first condition is satisfied, after a location of the first user terminal reaches the first spot that is one of a plurality of spots existing in the exhibition hall.

15. The exhibition information provision system according to claim 14, wherein
the first condition is that the first spot is one of the spots predefined by the first user.

16. The exhibition information provision system according to claim 14, wherein
the first condition is that the information of the first user satisfies conditions predefined by the spot management terminal at the first spot.

17. The exhibition information provision system according to claim 14, further comprising:
not transmitting the information of the first user to the spot management terminal at the first spot when movement of the first user terminal corresponds to a predefined gesture as a result of tracking the location of the first user terminal.

18. An exhibition information provision system comprising:
one or more processors; and
a memory that stores a computer program executed by the one or more processors, wherein
the computer program is stored on a computer-readable recording medium to execute:
obtaining visit information of a first user terminal for a plurality of spots existing in an exhibition hall, in which the visit information of the first user terminal includes a time for which the first user terminal has stayed at each of a plurality of spots; and
transmitting information about a first type of a second spot existing in the exhibition hall to the first user terminal based on a determination that a time for which the first user terminal has stayed at a first type of a first spot is equal to or more than a reference value, and
the visit information of the first user terminal is obtained as a result of tracking a location of the first user terminal within the exhibition hall.

19. The exhibition information provision system according to claim 18, wherein
obtaining the visit information of the first user terminal for the plurality of spots existing in the exhibition hall includes:
calculating each of a usage time and a waiting time of the first user terminal at the first spot, in which the usage time of the first user terminal at the first spot is a time for which the first user terminal has stayed inside a first area inside the first spot, and
applying a first weight to the usage time of the first user terminal at the first spot and applying a second weight to the waiting time at the first spot to determine a time for which the first user terminal has stayed at the first spot.

20. The exhibition information provision system according to claim 19, wherein
calculating the waiting time of the first user terminal at the first spot includes:
identifying that the first user terminal staying within a second area outside the first spot for a time equal to or more than a threshold, and
determining a time for which the first user terminal has stayed in the second area of the first spot as the waiting time of the first user terminal at the first spot when it is identified that the first user terminal has reached the first area of the first spot, and
the second area is at least a portion of a predefined adjacent area of the first spot.
